(19) United States
(12) Patent Application Publication
(10) Pub. No.: US 2015/0296836 A1
(43) Pub. Date: Oct. 22, 2015

(54) SOY PROTEIN CRISPS

(71) Applicant: ARCHER DANIELS MIDLAND COMPANY, Decatur, IL (US)

(72) Inventor: Michael J. Fleckenstein, Decatur, IL (US)

(21) Appl. No.: 14/434,452

(22) PCT Filed: Oct. 10, 2013
(86) PCT No.: PCT/US13/64273

§ 371 Date: Apr. 9, 2015

Related U.S. Application Data
(60) Provisional application No. 61/711,805, filed on Oct. 10, 2012.

(51) Int. Cl. A23J 3/26; A23J 3/16

(52) U.S. Cl. CPC A23J 3/26; A23J 3/16

(57) ABSTRACT

Improved soy protein crisps, containing at least 70% by weight of at least one hydrolyzed soy protein, wherein the crisp has a total protein content of at least 70% and a maximum moisture content of 7%, are disclosed. High protein crisps with superior functionality have been produced using one or more of partially hydrolyzed soy proteins having a degree of hydrolysis of 30 or more as determined by the TNBS method.

### TECHNICAL FIELD

The invention pertains to protein containing food products.

### BACKGROUND OF THE INVENTION

Many food products, particularly snack foods, are carbohydrate-based. However, the prevalence of carbohydrate-based foods has been linked to a rise in the incidence of obesity, diabetes, and other diseases.

Because many snack foods are processed, changing the formulation of a food product can be challenging. The product must still be palatable and digestible and the product must be capable of successfully being processed on existing manufacturing equipment. Furthermore, the new food product will need to have a taste, texture, and mouthfeel similar to existing carbohydrate-based food products.

US Patent Application Publication US 2009/0087536 described the production of crisp, expanded proteinaceous food products using a blend of at least partially hydrolyzed soy proteins and fully gelling or unhydrolyzed soy proteins. US Patent Application Publication US 2009/0087536 also disclosed a protein extrudate comprising about 70% to about 95% soy protein, where the soy protein is a blend of say proteins comprising an unhydrolyzed soy protein and an at least partially hydrolyzed soy protein.

In addition to consumers wanting snack foods having less carbohydrates, there is also demand to produce snack foods that are more natural, organic, non-GMO, and/or solvent free. Some protein sources (e.g., soy) may be solvent extracted to remove fat from the protein source. The extracted protein source is low in fat (e.g., less than 4% or less). There is a growing demand for protein sources that are not processed with solvents. Such protein sources may be defatted using a mechanical process such as expeller pressing. The mechanically processed protein sources may be higher in fat than the solvent extracted counterparts which may make processing the mechanically processed protein source challenging in existing food manufacturing equipment. Thus, needs exist to produce high protein snack foods and to produce solvent-free snack foods.

### SUMMARY OF THE INVENTION

In each of its various embodiments, the present invention fulfills these needs and discloses protein containing crisps which may be solvent-free.

In one embodiment, a crisp comprises at least 70% by weight of at least one hydrolyzed soy protein. The crisp has a total protein content of at least 70% and a maximum moisture content of 7%.

In another embodiment, a soy protein crisp consists essentially of at least 80% by weight of at least one hydrolyzed soy protein and a starch. The crisp has a total protein content of at least 80% and a maximum moisture content of 7%.

In yet a further embodiment a solvent-free crisp comprises a solvent-free soy protein and a starch. The crisp does not contain any solvent.

### DETAILED DESCRIPTION OF THE INVENTION

The applicants of the present invention have unexpectedly discovered that by using a partially hydrolyzed soy protein, a high protein crisp with superior functionality can be produced. In one embodiment, at least two at least partially hydrolyzed soy proteins can be used to create such high protein crisps. In a further embodiment, such high proteins crisps including the partially hydrolyzed soy protein may be produced without using any unhydrolyzed soy proteins.

At least partially hydrolyzed soy proteins as described herein refers to soy proteins that have a degree of hydrolysis of 30 or more as determined by the trinitro-benzene-sulfonic acid (TNBS) method. Un-hydrolyzed soy proteins as described herein refers to soy proteins that have a degree of hydrolysis of less than 30 as determined by the TNBS method.

In one embodiment, the crisp may be at least about 70% protein on an as-is basis.

Also disclosed are foodstuffs into which the high-protein crisps have been incorporated.

Also disclosed is a high-protein crisp consisting essentially of an at least partially hydrolyzed soy protein. Such crisp may also comprise at least one additional at least partially hydrolyzed soy protein and not contain any non-hydrolyzed protein.

In one embodiment, the high-protein crisps can have a protein content of at least about 70% on an as-is basis. In other embodiments, the high-protein crisps may have a protein content of at least 80% or even at least 85% protein. The crisps can have a carbohydrate content of less than about 5% on an as-is basis, e.g., from about 1% to about 3% on an as-is basis.

In a further embodiment, the crisps of the present invention have a density of between 0.02 g/cc to 0.5 g/cc.

Another embodiment discloses a method of increasing the protein content of a foodstuff, by incorporating the high-protein food crisp into the foodstuff.

In another embodiment, a solvent-free crisp including a solvent-free soy protein and a starch is described. The solvent-free soy protein may be soy flour, soy protein concentrate, soy protein isolate, or combinations of any thereof. The solvent-free soy protein may be expeller pressed soy flour and have a fat content of above 5% or between 7-12%. As used herein, the term solvent refers to a compound used to extract oil from an agricultural product during processing. Such solvents include, but are not limited to, various hexanes. The term solvent-free refers to the fact that a solvent has not been used to produce the ingredient referred to as “solvent-free.”

In one embodiment, the solvent-free soy protein comprises 45-80% protein on a moisture free basis, 45-65% protein on a moisture free basis, or 55-70% protein on a moisture five basis. The solvent-free crisp may also include an additional ingredient such as an edible bean powder, a fiber, or a combination thereof. The starch may be tapioca starch, rice flour, or a combination thereof. The solvent-free crisp may comprises 25-65% total protein by weight or at least 40% total protein by weight. The solvent-free crisp may also comprise 35-80% by weight of the solvent-free protein or at least 40% by weight of the solvent-free protein.

It should be understood that this invention is not limited to the embodiments disclosed in this summary, or the description that follows, but is intended to cover modifications that are within the spirit and scope of the invention, as defined by the claims.

Other than in the examples described herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one.” “a,” or “an” as used herein are intended to include “at least one” or “one or more,” unless otherwise indicated.

Any patent, publication, or other disclosure material, in whole or in part, that is said to be incorporated by reference herein in its entirety is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present invention includes high-protein crisps, and methods of making such crisps. The crisps are useful in that they present a high-protein product in a form normally associated by consumers with a high-carbohydrate product. As used herein, the term “high-protein” will be used to mean that the high-protein product has a protein content of at least about 70% on an “as-is” basis, that is at a level as the high-protein product is consumed by a customer or incorporated into a food product.

The crisp may be made from an at least partially hydrolyzed soy protein or a combination of at least partially hydrolyzed proteins.

In one embodiment, the high-protein crisp has a carbohydrate content of less than about 5% on an “as-is” basis, and in another embodiment the high-protein crisp has a carbohydrate content of about 1-3% on an “as-is” basis. In these embodiments, the carbohydrate may comprise, without limitation, a starch or a fiber.

Any type of soy protein can be used in the invention. Commercially available soy proteins include, but are not limited to soy protein concentrates, soy protein isolates, soy flours, and combinations thereof.

In an additional embodiment, a protein other than soy may be incorporated in the high-protein crisps of the present invention. Any type of protein can be included as the additional protein, including, but not limited to, milk protein, milk protein isolate, milk powders, buttermilk solids, whey protein, whey protein concentrate, whey protein isolate, caseinate, rennet casein, acid casein, egg protein, wheat protein, wheat protein isolate, modified wheat protein isolate, gluten, rice protein, zein, corn protein, canola protein, pea protein, potato protein, sesame protein, sunflower protein, cottonseed protein, copra protein, palm kernel protein, safflower protein, linseed protein, peanut protein, lupin protein, edible bean, oat protein, other legume or cereal proteins, hydrolyzed proteins, amino acids, peptides, and the like, and combinations thereof. In one embodiment, the additional protein is wheat gluten.

In another embodiment, an edible bean powder may be added to a crisp of the present invention. In one embodiment, the edible from which the edible bean powder originates may be of a Phaseolus species (i.e., beans). In further embodiments, varieties of beans that may be used to produce the bean powders used in the crisps of the present invention include, without limitation, Pinto beans, Great Northern beans, Navy beans, Red beans, Black beans, dark or light Red Kidney beans, Pink beans, MYASI beans, Mayocoba beans, Small Red beans, Black Eyed beans, Cranberry beans, White Beans, Rice beans, Butter beans, African Giraffe beans, and any combinations thereof.

In another embodiment, the edible bean powder may be produced by a milling process to produce the edible bean powder. The edible bean may be subjected to a form of crushing or pulverizing such as by passage of the dehydrated bean through a hammermill or universal mill. In one embodiment, the dehydrated bean product is ground in a PC-20 mill. The ground or powdered dehydrated bean product may be passed through a Swecoscreen 60 mesh, wherein the ground or powdered dehydrated been product has a particle size of less than about 0.250 mm. In another embodiment, the ground or powdered dehydrated bean product is produced such that about 95% of the ground or powdered dehydrated bean product passes through an 80 mesh screen. The ground or powdered dehydrated bean product may further be passed by a magnet to remove any metallic (i.e., iron-containing) contaminants.

Additional ingredients may be added to the high-protein crisps such as, for example, spices and seasonings, oils, and various processing aids, such as chemical additives which affect functionality and shelf life. Combinations of such ingredients may also be used. Other ingredients that may be added to the foodstuff include, but are not limited to, texture modifiers such as, for example, calcium carbonate.

“Seasonings” can include, but are not limited to, minerals such as salt, grain-based seasonings (such as, but not limited to, whole, cracked or ground wheat, corn, oats, rye, flax, barley, spelt and rice), plant-derived seasonings (such as, but not limited to, onion, garlic, pepper, capsicum pepper, herbs, spices, nuts, olives, fruits, vegetables, etc.), and other flavorings (such as, but not limited to, vanilla, sugar, cheese, yeast extract, whey), and combinations thereof.

Vitamins can also be included in the food product such as, but not limited to, niacin, iron, zinc, thiamine mononitrate (vitamin B1), riboflavin (vitamin B2), folic acid, tocopherol(s) (vitamin E), vitamin C, vitamin B6, vitamin B12, vitamin A, vitamin D, pantothenic acid and copper.

Edible oil and fat can also be included in the food product. Oils such as, but not limited to, soy, corn, canola, sesame, safflower, olive, sunflower, rapeseed, cottonseed, peanut, copra, palm kernel, palm, linseed, lupin, and combinations thereof can be used. Other fats such as butter or lecithin and their mixtures can also be used.

Other ingredients can be included such as emulsifiers (such as, but not limited to, lecithin, soy lecithin), leavening (such as, but not limited to, baking soda, calcium phosphate, yeast), natural and artificial sweeteners, preservatives (such as, but not limited to, BHT, BHA, and tocopherol), fiber (such as, but not limited to, insoluble fiber, soluble fiber), and any combinations of such ingredients. Fibers that may used include, but are not limited to, digestion resistant maltodextrin, inulin, polydextrose, maltodextrin, cellulose, or combinations of any thereof.

In one embodiment, the crisps of the present invention may be made with an extruder. In these types of machines, the dry ingredients may be mixed with water, and the resulting material may be extruded under high temperature and pressure. The material may be extruded out of the machine. When the pressurized material is exposed to atmospheric pressure and ambient temperature, it expands and cools, resulting in a puffed product. The puffed product can be of different shapes and sizes, depending on the die through which it passes and the frequency with which it is cut.

After extrusion, the product may be dried. The final product will have a moisture content of from about 1% to about 8%, depending on the desired characteristics of the finished product.

After production, the crisps are packaged for storage and/or sale. Any of the processes described herein may further include at least one of the following acts: placing the crisps in a container which may be configured for shipping; associating indicia with the container, such as, for example, placing graphical, written, or numerical indicia on the container, wherein the indicia may be capable of describing the contents of the container, designating the producer of the contents, and/or directing an end user, such as, for example, a consumer, on how to use the product; shipping the container containing the product, wherein any conventional method of shipping may be used, such as, for example, shipping by truck, train, ship, or plane; and combinations of any thereof.

The food product produced using the methods described herein can be in the form of crunchy curls, puffs, crisps, protein inclusions, etc. The product can be used as or in a snack food, cereal, or can be used as an ingredient in other foods such as a nutritional bar, breakfast bar, breakfast cereal, or candy.

In various embodiments, the processing conditions and the amounts and types of ingredients can be modified so as to change the nutritional levels of the finished product, as well as for altering the handling, stability, shelf life, texture, flavor, functional properties and ease of manufacture of the product.

The present invention may be further understood by reference to the following examples. The following examples are merely illustrative of the invention and are not intended to be limiting. Unless otherwise indicated, all parts are by weight.

### EXAMPLES

### Example 1

### Formulations for High-Protein Soy Crisps

80% protein soy crisps were produced using at least partially hydrolyzed soy proteins. The formulations of the crisps prepared are listed in Table 1.

TABLE 1
Formulations of soy crisps.

| Ingredient | Run 1 | Run 2 | Run 3 |
|---|---|---|---|
| Soy protein isolate, | 30.45% | — | 31.01% |
| TNBS of 33.5 | | | |
| Soy protein isolate, | 56.55% | 6.46% | 55.99% |
| TNBS of 77 | | | |
| Tapioca starch | 12.50% | 12.37% | 12.37% |
| Calcium carbonate | 0.50% | 1.50% | 1.50% |
| Soy protein isolate, | — | 79.67% | — |
| TNBS of 40 | | | |

In each of the formulations of Table 1, the ingredients were blended in a ribbon blender. The blend was transferred to a live bottom bin feeding a Wenger TX 52 twin screw extruder, 19.5/1 L/D, with a K screw configuration. The extruder screw profile was made up of a combination of feed screws, and forward and reverse shearlocks. The end die plate contained two 1.5×3 mm oval dies. The blended material was fed into the feed throat of the extruder, and water was added. The extruder specifications and extrusion temperatures were set (from inlet to die) screw speed as shown in Table 2. The extrudate was cut into small crisps with a rotating knife. These crisps were dried.

TABLE 2
Head Temp. is in degrees F.

| Extruder Condition | Run 1 | Run 2 | Run 3 |
|---|---|---|---|
| Extruder rpm | 280 | 300 | 265 |
| Cylinder rpm | 126 | 126 | 126 |
| Feeder rpm | 11 | 11 | 11 |
| % load | 26 | 29 | 26 |
| Knife (6) | 2075 | 1930 | 2235 |
| Head Temp. zone 1 | 138 | 143 | 134 |
| Head Temp. zone 2 | 151 | 151 | 151 |
| Head Temp. zone 3 | 166 | 167 | 173 |
| Head Temp. zone 4 | 228 | 235 | 232 |
| Head Temp. zone 5 | 249 | 250 | 248 |
| Head Temp. zone 6 | 255 | 263 | 254 |
| Water | 255 ml | 320 ml | 295 ml |
| Density | 245 | 240 | 221 |

Run 1 produced nice crisps which were similar to commercially available crisps. Run 2 produced very good crisps which would be commercially acceptable. Run 3 produced good crisps which would be commercially acceptable.

### Example 2

### Solvent Free Soy Crisps

Solvent free soy crisps were produced using a soy protein source (i.e., soy flour) that was expeller pressed, instead of using a hexane extracted soy protein. The formulations of the crisps prepared are listed in Table 3. Run 1 used expeller pressed soy flour and Runs 2-5 used low fat soy flour, all of which were solvent free.

TABLE 3
Solvent free crisp formulations.

| Ingredient | Run 1 | Run 2 | Run 3 | Run 4 | Run 5 | Run 6 |
|---|---|---|---|---|---|---|
| Soy flour | 35.00% | 43.00% | 40.00% | 42.22% | 50.00% | 60.00% |
| Navy bean powder | 35.00% | 25.00% | 30.00% | 31.11% | 21.00% | 20.00% |
| Rice Flour | 30.00% | — | — | 26.67% | — | — |
| Tapioca starch | — | 22.0% | 30.00% | — | 29.00% | 20.00% |

In each of the formulations listed herein, the ingredients were blended in a ribbon blender. The blend was transferred to a live bottom bin feeding a Wenger TX 52 twin screw extruder, 19.5/1 L/D with a K screw configuration. The extruder screw profile was made up of a combination of feed screws, and forward and reverse shearlocks. The end die plate contained two 1.0×1.0 mm round dies. The blended material was fed into the feed throat of the extruder, and water was added. The extruder specifications and extrusion temperatures were set (from inlet to die) screw speed as shown in Table 4. The extrudate was cut into small crisps with a rotating knife. These crisps were dried.

TABLE 4
Extruder conditions. Head Temp. is in degrees F.

| Extruder | | | | | | |
|---|---|---|---|---|---|---|
| Condition | Run 1 | Run 2 | Run 3 | Run 4 | Run 5 | Run 6 |
| Extruder rpm | 420 | 335 | 306 | 295 | 280 | 280 |
| Cylinder rpm | 126 | 125 | 125 | 125 | 125 | 125 |
| Feeder rpm | 13 | 10 | 10 | 10 | 10 | 10 |
| % load | 31 | 32 | 32 | 35 | 40 | 37 |
| Knife (6) rpm | 2820 | 3500 | 3500 | 3500 | 3500 | 3500 |
| Head Temp. | 131 | 122 | 122 | 116 | 119 | 118 |
| zone 1 | | | | | | |
| Head Temp. | 125 | 107 | 134 | 135 | 133 | 134 |
| zone 2 | | | | | | |
| Head Temp. | 162 | 201 | 206 | 201 | 204 | 205 |
| zone 3 | | | | | | |
| Head Temp. | 247 | 279 | 280 | 275 | 278 | 278 |
| zone 4 | | | | | | |
| Head Temp. | 279 | 300 | 309 | 301 | 304 | 305 |
| zone 5 | | | | | | |
| Head Temp. | 271 | 275 | 277 | 268 | 264 | 264 |
| zone 6 | | | | | | |
| Water | 200 ml | 290 ml | 295 ml | 295 ml | 295 ml | 295 ml |
| Density | 240 | 205 | 222 | 185 | 227 | 193 |

Each of Runs 1-6 produced good soy crisps that would be commercially acceptable. The crisps had the following amounts of protein: Run 1, 25%; Runs 2-3, 30%; Runs 4-5, 35%; and Run 6, 40%.

While this invention has been particularly shown and described with references to exemplary embodiments thereof, it will be understood by those skilled in the art that various changes in form and details may be made therein without departing from the scope of the invention encompassed by the appended claims.

1. A crisp, comprising:
at least 70% by weight of at least one hydrolyzed soy protein;
the crisp having a total protein content of at least 70%;
the crisp having a maximum moisture content of 7%.

2. The crisp of claim 1, further comprising a starch.

3. The crisp of claim 1, further comprising a texture modifying ingredient.

4. The crisp of claim 1, wherein the at least one hydrolyzed soy protein has a TNBS of 30 or more.

5. The crisp of claim 1, wherein the at least one hydrolyzed soy protein comprises a first hydrolyzed soy protein having a TNBS of 30 or more and a second hydrolyzed soy protein having a TNBS of 30 or more.

6. (canceled)

7. The crisp of claim 1, wherein the at least one hydrolyzed soy protein is a soy protein isolate.

8. (canceled)

9. The crisp of claim 3, wherein the texture modifying ingredient comprises calcium carbonate.

10. The crisp of claim 1, further comprising a fiber.

11. (canceled)

12. A soy protein crisp consisting essentially of:
at least 80% by weight of at least one hydrolyzed soy protein;
wherein the at least one hydrolyzed soy protein comprises a first hydrolyzed soy protein having a TNBS of 30 or more and a second hydrolyzed soy protein having a TNBS of 30 or more; and
a starch;
the crisp having a total protein content of at least 80%;
the crisp having a maximum moisture content of 7%.

13. (canceled)

14. The soy protein crisp of claim 12, wherein the at least one hydrolyzed soy protein has a TNBS of 30 or more.

15. The soy protein crisp of claim 12, wherein the at least one hydrolyzed soy protein is a soy protein isolate.

16-21. (canceled)

22. A solvent-free crisp, comprising:
a solvent-free soy protein; and
a starch;
wherein the crisp does not contain any solvent.

23. The solvent-free crisp of claim 22, wherein the solvent-free soy protein has a protein content of 45-80% on a moisture free basis.

24-25. (canceled)

26. The solvent-free crisp of claim 22, wherein the solvent-free soy protein has a fat content of 7-12%.

27. The solvent-free crisp of claim 22, wherein the solvent-free protein has a fat content of at least 5%.

28. The solvent-free crisp of claim 22, further comprising an edible bean powder.

29. The solvent-free crisp of claim 22, wherein the starch is rice flour.

30. The solvent-free crisp of claim 22, wherein the starch is tapioca starch.

31. The solvent-free crisp of claim 22, wherein the solvent-free soy protein is expeller pressed soy flour.

32-34. (canceled)

35. The solvent-free crisp of claim 22, wherein the solvent-free crisp comprises between 25-65% total protein by weight.

36-40. (canceled)
